(19) United States
(12) Patent Application Publication
(10) Pub. No.: US 2009/0026669 A1
(43) Pub. Date: Jan. 29, 2009

(54) Adjusting Device

(75) Inventor: Alexander Kneip, Macken (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/180,609

(22) Filed: Jul. 28, 2008

(30) Foreign Application Priority Data
Jul. 26, 2007 (DE) 10 2007 035 078.5

(51) Int. Cl. F16F 9/56; F16F 9/02; B60J 5/00

(52) U.S. Cl. 267/120; 92/18; 267/64.11; 296/146.1

(57) ABSTRACT

Disclosed is an adjusting device for raising a hinged lid from a lowered, closed position into a raised, open position, especially for a motor vehicle, with a cylinder closed at one end, a piston, which divides the interior space of the cylinder into a first working chamber and a second working chamber, and which is installed with freedom to move axially back and forth in the cylinder, a piston rod, attached to the piston, the rod extending axially through the first working chamber and projecting through a seal to the outside, one or more flow connections connecting the first working chamber to the second working chamber, and a first adjusting element and a second adjusting element, wherein the first and second adjusting elements are designed to telescope into and out of each other and have guide devices, which make it possible to open the hinged lid into a partially opened position or into a completely opened position.

### BACKGROUND OF THE INVENTION

1. Field of the Invention

The invention pertains to an adjusting device for raising a hinged lid from a lowered, closed position into a raised, open position, especially for motor vehicles.

2. Description of the Related Art

In the case of the hinged lids of motor vehicles, especially hatchbacks, it is frequently desirable for the gas spring arrangement to move the lid not only into its completely open position but also into an intermediate position, that is, into a partially opened position.

The reason for this could be that the motor vehicle is parked in a low-ceiling parking space, where raising the lid into the completely open position would cause it to strike the ceiling, or that the person using the motor vehicle is not tall enough to reach the completely opened lid to close it.

### SUMMARY OF THE INVENTION

It is therefore desirable to create a gas spring arrangement of the type indicated above which is simple in design and which makes it possible to raise the hinged lid either into a partially opened position or into a completely opened position.

In one embodiment the invention the adjusting device comprises a pressure medium-filled cylinder, in which a piston, which divides the interior space into a first working chamber and a second working chamber, is installed with freedom to slide axially back and forth. The piston comprises a piston rod, which extends axially through the second working chamber and projects through a seal to the outside. One or more flow connections are provided to connect the first working chamber to the second working chamber. The device also has a first adjusting element and a second adjusting element, where the first and second adjusting elements are designed to telescope into and out of each other and comprise guide devices, which make it possible to raise the hinged lid into a partially opened position or into a completely opened position.

In one embodiment, the guide device of the first adjusting element comprises a recessed guide track, and the guide device of the second adjusting element comprises a guide pin, which cooperates with the recessed guide track.

In one embodiment, the first and second adjusting elements to be designed as tubular housing parts, which protect the adjusting device from external influences such as dust and moisture.

In one embodiment, the guide track to be formed by a recess in the first adjusting element, as a result of which an almost completely continuous, smooth surface is obtained, which means that the adjusting device also acquires an attractive appearance.

In another embodiment, the recessed guide track can be formed by one or more guide webs in the first adjusting element. As a result, material can be saved in the production of the first adjusting element.

The recessed guide track comprises a main branch, which splits into a first secondary branch and a second secondary branch, where the first secondary branch makes it possible for the hinged lid to move into the partially opened position, whereas the second secondary branch makes it possible for the lid to move into the completely opened position.

Between the adjusting elements and the cylinder, a spring device is provided, which makes it easier to open the hinged lid in a manner which is insensitive to temperature, because, when only a gas spring is used, opening the lid at different temperatures becomes difficult, especially at extremely cold or extremely hot temperatures.

The spring device is supported against an annular disk mounted at the closed end of the cylinder and against an annular disk installed on the end of the piston rod projecting out of the cylinder.

To damp outward movement of the lid into the intermediate position, a buffer device is installed between the annular disk and a bottom piece, which closes off the second adjusting element.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

Exemplary embodiments of the invention are shown in the drawing and are described in greater detail below:

FIG. 1a shows a plan view of an inventive adjusting device;

FIG. 1b show a longitudinal cross section through the adjusting device of FIG. 1a;

FIG. 2 shows an exploded view of the adjusting device shown in FIGS. 1a and 1b;

FIG. 3a shows a view of a component of the adjusting device in isolation;

FIG. 3b show a longitudinal cross section through the component of FIG. 3a;

FIG. 4 shows a developed view of part of the component illustrated in FIGS. 3a and 3b; and

FIG. 5 shows another embodiment of the component shown in FIGS. 3a and 3b.

### DETAILED DESCRIPTION OF THE PRESENTLY PREFERRED EMBODIMENTS

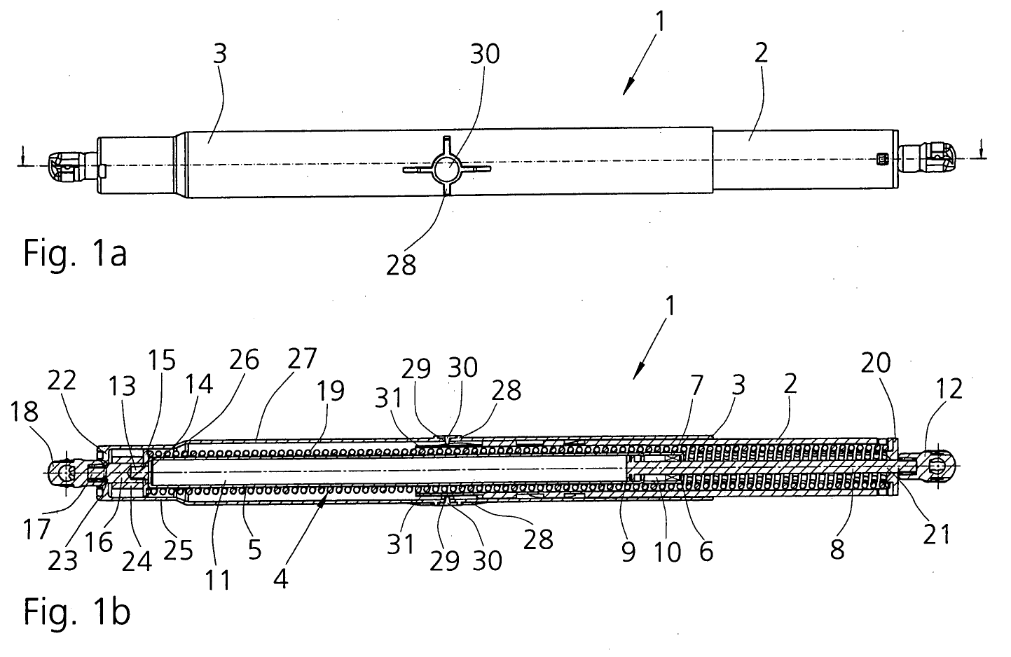

FIG. 1a shows an adjusting device 1 with a cylindrical first adjusting element 2 and a cylindrical second adjusting element 3, where at least part of the first adjusting element 2 is located inside the second adjusting element 3 and can be pushed into it in a telescoping manner.

FIG. 1b shows a longitudinal cross section through the adjusting device 1. Inside the two adjusting elements 2 and 3, a piston-cylinder unit 4 is installed, which can be formed by, for example, a gas spring or a damper. The piston-cylinder unit 4 comprises a cylinder 5, which is filled with a fluid, such as gas and/or oil, a piston rod 8, which passes out of the first end 6 of the cylinder 5 by way of a sealing and guide package 7, and a piston 9, which is attached to the end of the piston rod projecting into the cylinder 5. The piston 9 is configured to slide back and forth in the cylinder 5, and divides the interior space of the cylinder 5 into a first working chamber 10 on the piston rod-side of the piston and a second working chamber 11 on the side of the piston facing away from the piston rod. The end of the piston rod 8 projecting out of the cylinder 5 is coupled to a connecting element 12 designed in the form of a ball socket, by means of which the adjusting device 1 can be coupled to a component whose position is to be shifted (not shown), such as a hinged lid of a motor vehicle, or to a component such as a vehicle body which is stationary relative to the component whose position is to be shifted.

Opposite the first end 6, the cylinder 5 has a second end 14, which is closed off by flanging and by a welded-on pin 13. The pin 13 has an outside thread, over which an annular disk 15 is pushed and onto which an adapter element 16 with an inside thread is screwed, as a result of which the annular disk 15 is held in place on the threaded pin 13. The end of the adapter element 16 opposite the pin 13 has a pin 17 with an outside thread, to which a coupling element 18, designed as a ball socket, is attached. By means of the connecting element 18, the adjusting device 1 can be attached either to the stationary component or to the component whose position is to be shifted.

The annular disk 15 serves as an axial support for a spring device 19, which extends axially from the annular disk 15 and winds in helical fashion around the piston-cylinder unit 4 to the end of the piston rod 8 which projects out of the cylinder 5. The spring device 19 is also supported against another annular disk 20, which is pushed by the spring device 19 against the coupling element 12.

The annular disk 20 closes off the first adjusting element 2 but has an opening 21, through which the piston rod 8 passes. The annular disk 20 can be screwed onto the first adjusting element 2 or can be formed as an integral part of it.

The end of the second adjusting element 3, which faces the connecting element 18, is closed off by a bottom piece 22 and has an opening 23 through which the pin 17 of the adapter element 16 extends outward from the second adjusting element 3. Between the closed end of the second adjusting element 3 and the annular disk 15, a sleeve-like buffer device 24 surrounding the adapter element 16 is provided. By screwing the connecting element 18 onto the pin 17, the second adjusting element 3 is held in place on the adapter element 16.

The second adjusting element 3 has a section 25 of reduced diameter in the area of the adapter element 16 and the second end 14 of the piston-cylinder unit 4; it also has a second conical section 26 extending conically from the section 25 toward the open end of the adjusting element 3. This conical section 26 forms a transition to a section 27 of larger diameter. Two essentially cross-shaped areas 28 of increased thickness, each with a bore 29, are formed in the second adjusting element 3 approximately in the middle of section 27. Each of the cross-shaped areas 28 has a bore 29. A guide pin 30, which is preferably permanently connected to the second adjusting element 3 by ultrasonic welding, for example, or by adhesive bonding, or by some other suitable method, is inserted into each of the bores 29.

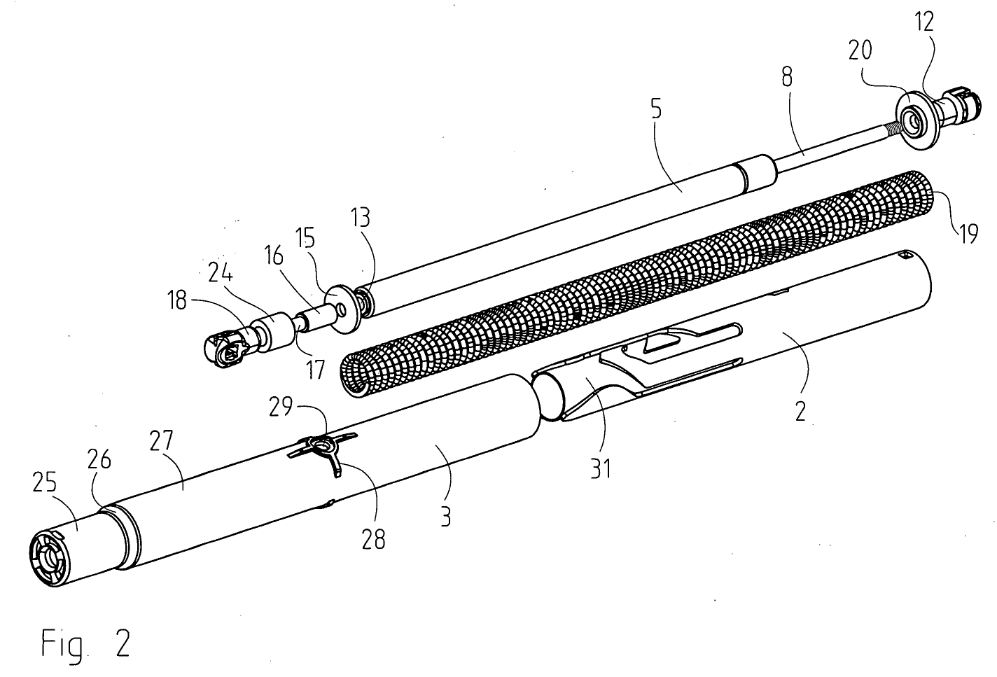

The guide pin 30 engages in a recessed guide track 31, shown in detail in FIG. 2, which is located on the outside lateral surface of the first adjusting element 2.

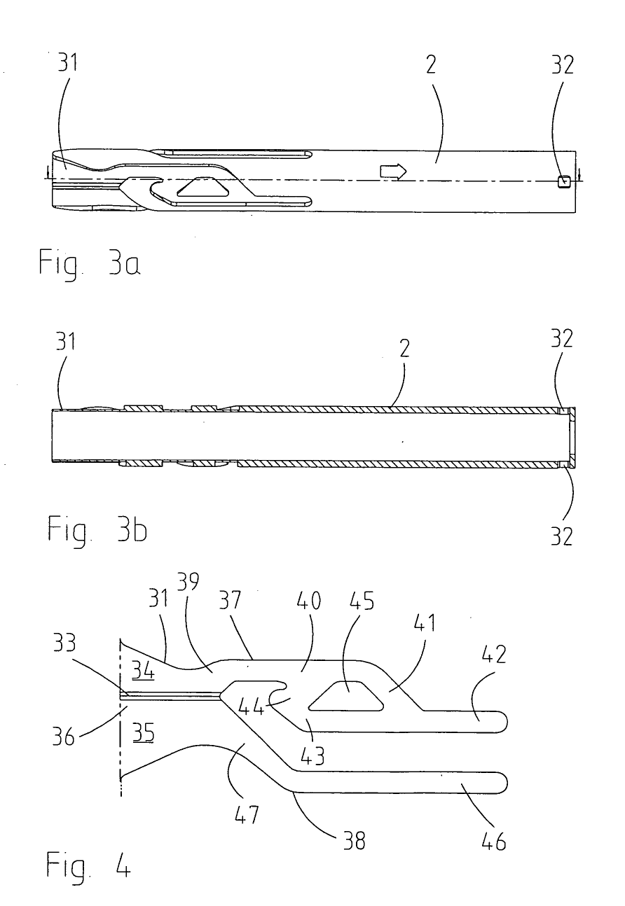

FIG. 3a shows a detailed top view of the first adjusting element 2, in which large parts of the recessed guide track 31 can also be seen. The recessed guide track 31 extends essentially in the axial direction from the end opposite the end closed off by the annular disk 20 along the outside surface of the first adjusting element 2. At the end of the first adjusting element 2 opposite the recessed guide track 31, an opening 32 can be seen, through which air can flow in and out when the first adjusting element 2 is moved into or out of the second adjusting element 3.

It can be seen in FIG. 3b that several openings 32 can be provided in the first adjusting element 2.

FIG. 4 shows part of a developed view of the lateral surface of the first adjusting element 2, in particular of the recessed guide track 31. The recessed guide track 31 comprises a main branch 36, divided by a web-like elevation 33 into a first field 34 and a second field 35. The main branch splits into a first secondary branch 37 and a second secondary branch 38. The first secondary branch 37 comprises a first curved section 39, which connects the first field 34 of the main branch 36 to a first straight section 40 extending in the axial direction. From the first straight section 40, there extends a second curved section 41, which merges with the flank of a straight, axial section 42 of the first secondary branch 37. From the end of the second straight section 42 near the main branch 36, a third curved section 43 proceeds, on which a valley-like latching point 44 is formed. The third curved section 43 leads back to the first straight section 40. Thus part of the first straight section 40, the second curved section 41, part of the second straight section 42, and the third curved section 43 form an island-like elevation 45.

The second secondary branch 38 comprises a straight section 46 extending in the axial direction, which is connected by a curved section 47 to the second field 35 of the main branch 36.

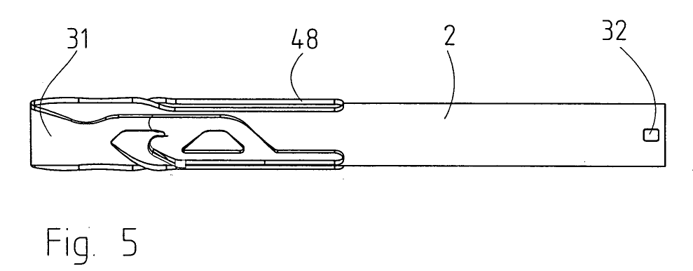

FIG. 5 shows another exemplary embodiment of the first adjusting element 2, in which the recessed guide track 31 is formed only by projecting guide webs 48, as a result of which the wall of the first adjusting element 2 is thinner overall.

The adjusting device 1 is intended to make it possible to move the hinged lid of a motor vehicle, for example, into a completely open position or into a partially opened position. In the completely opened position of the lid is it possible, by turning the second adjusting element 3 relative to the first adjusting element 2, to preset the adjusting device 1 in a way which allows the lid to be opened either completely or partially. In the completely opened position of the lid, the piston rod 8 is pushed out of the cylinder 5, and the first adjusting element 2 is pushed out of the second adjusting element 3, where the two adjusting elements still overlap each other, in particular in the area of the recessed guide track 31. The guide pin 30 of the second adjusting element 3 is now located in the main branch 36 of the first adjusting element 2.

When the hinged lid is to be raised into the completely open position, the second adjusting element 3 is turned relative to the first adjusting element 2 in such a way that the guide pin 30 is located in the second field 35 of the main branch 36 of the recessed guide track 31. If the guide pin 30 was previously located in the first field 34 of the main branch 36, it is moved into the second field 35 over the web-like elevation 33 in a manner which the user can easily detect. As the lid is being closed, the guide pin 30 moves along the curved section 47 and then along the straight section 46 until the lid is closed. Devices for damping the movement of the hinged lid such as one or more axial grooves of varying cross sections (which are known and therefore not shown in the figures), for example, can be provided in the wall of the cylinder 5.

When the hinged lid is now raised again with support by the piston-cylinder unit 4 and/or the spring device 19, the guide pin 30 moves along the straight section 46 and the curved section 47 back into the second field 35 of the main branch 36 of the recessed guide track 31. The lid is now completely open again. This procedure can be repeated as often as desired. So that no positive or negative pressure can develop inside the two adjusting elements, air can flow in or out through the openings 32.

Now let it be assumed that the user wishes to move the hinged lid into the partially opened position. While the lid is in the opened position, the second adjusting element 3 is turned relative to the first adjusting element 2 in such a way that the guide pin 30 is located in the first field 35 of the main branch 36 of the recessed guide track 31. If the guide pin 30 was previously in the second field 35 of the main branch 36, it moves into the first field 34 over the web-like elevation 33 in a manner which the user can easily detect. It should also be pointed out here that markings or symbols can be provided on the first adjusting element 2 and on the second adjusting element 3 to show whether the adjusting device 1 is in the position for opening the lid into the completely opened position or in the position for opening it into the partially open position, When the lid is now closed, the guide pin 30 will move along the second straight section 42, past the island-like elevation 45, along the third curved section 43 and into the latching point 43 where it will remain, because the spring device or the piston-cylinder unit is attempting to push the two adjusting elements farther apart from each other. So that the guide pin 30 does strike the latching point 44 with force, the buffer device 24 takes care of damping the contact.

To close the lid, the guide pin 30 is pressed against the elevation 45 and guided into the first straight section 40, from which it proceeds via the second curved section 41 to the second straight section 42 and axially onward along this section until the lid is closed. Axial grooves in the cylinder 5 can again ensure a damping effect on the closing movement.

The next time the lid is opened, the guide pin again moves as far as the latching point 44. The lid can be closed and opened into the not completely opened position as often as desired.

To open the lid into the completely opened position again, the guide pin 30 must be moved out of the latching point 44 by briefly pushing down the lid, approximately so far that it is guided by the elevation 45 into the first straight section 40. Then the lid can be released, as a result of which, supported by the spring device 19 or by the piston-cylinder unit 4, it moves into the completely outward-extended position. If the hinged lid is closed and then opened again, the guide pin 30 will again move only as far as the latching point 44.

So that the preset adjustment can be changed, however, the hinged lid must be in the completely opened position, and then the second adjusting element 3 must be rotated relative to the first adjusting element 2 so that the guide pin 30 moves from the first field 34 of the main branch 36 of the recessed guide track 31 into the second field 35.

The invention is not limited by the embodiments described above which are presented as examples only but can be modified in various ways within the scope of protection defined by the appended patent claims.

I claim:

1. An adjusting device for raising a hinged lid from a lowered, closed position into a raised, open position, especially for a motor vehicle, comprising:
a cylinder closed at one end;
a piston, which divides the interior space of the cylinder into a first working chamber and a second working chamber, and which is installed adapted to move axially in the cylinder;
a piston rod, attached to the piston, the rod extending axially through the first working chamber and projecting through a seal;
at least one flow connections connecting the first working chamber to the second working chamber;
a first adjusting element and a second adjusting element;
wherein the first and second adjusting elements are designed to telescope into and out of each other when the piston rod is moved into and out of the cylinder and have guide devices, which make it possible to selectively open the hinged lid into a partially opened position or into a completely opened position.

2. The adjusting device according to claim 1, wherein the guide device of the first adjusting element comprises a recessed guide track.

3. The adjusting device according to claim 2, wherein the guide device of the second adjusting element comprises a guide pin that cooperates with the recessed guide track.

4. The adjusting device according to claim 3, wherein the first and second adjusting elements are tubular housing parts.

5. The adjusting device according to claim 2, wherein the recessed guide track is formed by a recess in the first adjusting element.

6. The adjusting device according to claim 5, wherein the recessed guide track is formed by one or more guide webs in the first adjusting element.

7. The adjusting device according to claim 2, wherein the recessed guide track comprises a main branch, which splits into a first secondary branch and a second secondary branch.

8. The adjusting device according claim 7, wherein the first secondary branch is configured for the hinged lid to be moved into the partially opened position.

9. The adjusting device according to claim 7, wherein the second secondary branch is configured for the hinged lid to be moved into the completely opened position.

10. The adjusting device according to claim 1, wherein a spring device is arranged between the adjusting elements and the cylinder.

11. The adjusting device according to claim 10, wherein the spring device is supported on an annular disk located at the closed end of the cylinder and on an annular disk located on the end of the piston rod which projects out of the cylinder.

12. The adjusting device according claim 11 further comprising a buffer device located between the annular disk and a bottom piece, which closes off the second adjusting element.
